(19) United States
(12) Patent Application Publication
(10) Pub. No.: US 2008/0315150 A1
(43) Pub. Date: Dec. 25, 2008

(54) Antifreeze Material for Outdoor Sites, Typically Roads

(75) Inventor: Ciro Parisi, Livorno (IT)

Correspondence Address: STRADLEY RONON STEVENS & YOUNG, LLP, 30 VALLEY STREAM PARKWAY, GREAT VALLEY CORPORATE CENTER, MALVERN, PA, 19355-1481, US

(73) Assignee: Claudia Leo, Castel Sant'Angelo (IT)

(21) Appl. No.: 11/915,833

(22) PCT Filed: May 15, 2006
(86) PCT No.: PCT/EP2006/004630

§ 371 Date: May 22, 2008

(30) Foreign Application Priority Data
May 30, 2005 (IT) RE 2005 A000062

(51) Int. Cl. C09K 5/06

(52) U.S. Cl. 252/71

(57) ABSTRACT

Antifreeze material typically for outdoor constructions, such as roads and the like, comprising a loose material of generally granular form and generally porous structure which does not degrade in the presence of water and does not immediately completely disaggregate when subjected to compressive action due to treading and/or tyre rolling thereon, and which is impregnated by a generally water-soluble antifreezing product.

### TECHNICAL FIELD

The present invention relates, in a totally general sense, to the generally antifreezing and/or anti-skid surface treatment of outdoor constructions, such as roads, paths, squares, courtyards and the like, and more particularly to a material for effecting such a treatment.

The invention also relates to a method for preparing said antifreeze and/or antiskid material.

### PRIOR ART

The problems resulting from bad weather typical of generally winter periods, such as snowfalls, ice and hailstones are well known, the particularly important effects of which include for example difficult travel both on foot and by vehicle, with its accompanying dangers.

For simplicity, the effect of a snowfall will be considered as typical of all these cases.

Apart from the intervention of suitable snowploughs, obviously required when fairly deep snow layers are present, in accordance with the known art for combating the snow (and/or ice) present typically on roads and motorways, saline products such as rock salt are used, the obvious purpose of which is to lower the freezing point of water.

Sometimes a small quantity of crushed or uncrushed river or quarry gravel is added to said salt.

If a snowfall is predicted, said salt (with or without gravel) is distributed directly over the road surface by a suitable salt spreader, whereas if the snowfall is in progress or has ceased, the salt is spread over the road after removal (generally incomplete) of the snow (and/or ice) present thereon by a snowplough which carries said salt spreader on board or is followed thereby.

The limits connected with the use of said salt, either as such or mixed with gravel, include a fairly short life of its antifreeze effect.

This is because the salt is directly exposed overall to the environment, in particular to being washed away after periods of bad weather, particularly in the presence of rain and/or sudden temperature increases.

In this respect, in the said case of prior spreading of salt when a snowfall is predicted, if the snowfall does not take place and instead it rains, the salt dissolves rapidly and is discharged from the road surface together with the rain water.

If instead it actually snows, then the salt performs its antifreeze function (substantially as if spread after a snowfall), to at least partly dissolve the surrounding snow and prevent ice formation (within the limits imposed by the external temperature and local salt concentration).

When it ceases to snow and the ambient temperature rises, the snow melts and the water which forms washes away the salt, this process being more rapid the heavier and faster the traffic transiting the site in question, particularly in combination with an ambient temperature increase and/or if rain is present.

The main object of the present invention is to overcome the limitations of the initially described salt spreading method.

### DISCLOSURE OF THE INVENTION

Said object is attained by a generally antifreeze material presenting the characteristics indicated in the main claim.

Preferred and advantageous formulations thereof are indicated in the dependent claims.

In a totally general sense, to achieve said objective, a material is provided which incorporates, or contains, a generally antifreezing product, such as sea salt, and is arranged to release it in a relatively slow manner, even in the presence of a high degree of wetness, such as a layer of water due to rain or melting snow.

The objective of the invention is hence achieved, in that the aforesaid characteristic, i.e. said slow release of the antifreezing product, enables the material of the invention to be less sensitive to said wash-away phenomenon, and hence achieve an antifreeze effect which for equal conditions is more prolonged than that of rock salt directly spread over the ground, as already stated.

The basic material of the invention is a loose material of generally granular form and generally porous structure which does not degrade in the presence of water.

Said loose material may or may not withstand the compressive action due either to treading or to tyre rolling thereon, in the sense that it does not immediately completely disaggregate when subjected to such action. Said porous structure acts as a receptacle for a generally antifreezing product, such as generally wet sea salt, for which the loose material acts as the carrier or release vehicle.

The porous structure is preferably of the intercommunicating cell or pore type (similar to a sponge), said cells or pores being relatively small in relation to the size of the particles of loose material.

Said particles, or grains, can be of generally round or spherical shape, with an average size for example of about 5 mm, their cells or pores having micrometric dimensions, of the order for example of 15-25 Å, and are distributed substantially uniformly within the bulk of the respective particles or grains.

Characteristics or properties of this type can for example be found in natural argillaceous minerals of the sepiolite-paligorskite family. In particular, sepiolite is a magnesium hydrate silicate the structure of which presents parallel chains of needle-shaped crystals alternating with free channels arranged along the crystalline fibres or chains.

Because of this, it is able to absorb a large quantity of water (even 100% and more of its own weight) without swelling or altering in any way. It is of very low cost and does not pollute, being a natural material.

Such characteristics are present in an argillaceous material such as attapulgite, which is hence suitable for use within the context of the invention. Tests carried out have shown that natural calcium-based minerals and preparations for domestic use are also suitable, for example those used as granular litter for domestic animals.

Essentially, what is important is that the loose material acting as the vehicle for the antifreezing saline product does not become immediately crushed or disaggregated by said treading or tyre rolling action, has a porous structure with generally communicating cells, and can be impregnated with a wet antifreezing product.

A convenient antifreezing product for the purposes of the invention is common salt—sodium chloride—not necessarily refined, i.e. natural.

### BEST MODE FOR CARRYING OUT THE INVENTION

A material according to the invention having a preferred formulation was prepared by the following procedure.

A quantity of water was fed into a container, such as a tank, and sea salt was gradually added until the water was virtually completely saturated therewith (indicated by monitoring with a suitable hydrometer or other similar apparatus).

To accelerate the process the liquid was continuously stirred. In comparative tests, the liquid was not only stirred but also heated (generally to below the boiling point of water), this achieving better results in terms both of the time needed to obtain the required solution and the increase of solute salt concentration in the dissolving water.

After obtaining the brine solution (water+salt), a suitable quantity of generally granular inert material was immersed in it (in the case of sepiolite this quantity being virtually equal to the weight of the solution). The mixture was stirred while maintaining the bath heated, until the inert material (such as sepiolite) was virtually completely impregnated.

The impregnated inert material, if necessary drained and left to at least partially cool, was then packaged in suitable sealed containers, such as barrels, drums, buckets with a snap-on lid, or thermowelded synthetic bags.

This antifreeze material was used on snow-covered roads, paths, squares and courtyards, by distribution in the same manner as the usual rock salt under comparable climatic conditions, it being found that it produced substantially the same results as the said salt, the effects however lasting for a much longer time, equal to about three times that of said rock salt. This was because the material continued to release salt even after being washed repeatedly with appropriate water jets.

Tests were then carried out aimed at improving the retention time of the material of the invention on surfaces, typically road surfaces, used by vehicle traffic, which is known to give rise to rapid displacement of loose material present on the road towards the centre and sides of the road. These tests showed that the material offers good resistance to displacement by the rolling of tyres if the material has fairly sharp edges, and still better if flat in shape, similar to flakes or scales.

If the material is of round granular shape, its structure may not be particularly resistant, in the sense that it may fracture, but without complete disaggregation, under the effect of treading or tyre rolling.

Other improvements to the antifreeze material of the invention, in particular regarding prolongation of the time required to release all the contained salt, were achieved by adding a suitable retardant preparation to the salt/water solution.

Specifically, after preparing said brine solution, but before adding the inert material to it, the solution was cooled to about ambient temperature, after which a certain quantity of said preparation was added to it.

Good results were achieved by using an economical non-pollutant substance, such as ethyl alcohol of about 95% purity, added to the solution in a quantity of about 5% of the solution weight.

When used on snow-covered roads as in the previous case, the antifreeze material containing alcohol had a salt release time practically double that found for the material without alcohol.

This is because when used under said conditions, i.e. in low temperature, the ethyl alcohol evaporates fairly slowly with the result of immediately providing a type of filtering barrier towards salt dilution by the moisture present on the site on which the loose material is used.

Said material containing a retardant preparation such as ethyl alcohol also falls within the scope of protection of the invention.

An example of a material formulation comprising said retardant preparation is the following.

To prepare 20 kg of antifreeze material of the invention, the following weight quantities of the respective components were used: about 5 kg of mains water, about 2 kg of natural sea salt, about 12 kg of domestic animal litter, about 1 kg of ethyl alcohol.

1-12. (canceled)

13. A granular composition to prevent freezing on a surface, the compositon comprising:
porous inorganic particles comprising at least one natural argillaceous sepiolite mineral, wherein the porous inorganic particles are impregnated with sodium chloride by a process comprising the steps of:
forming a saturated aqueous solution of sodium chloride;
adding the porous inorganic particles to the saturated aqueous solution of sodium chloride under agitation to impregnate the porous inorganic particles with the sodium chloride;
separating the impregnated porous inorganic particles from the solution; and
drying the impregnated porous inorganic particles.

14. The compostion of claim 1 wherein the process further includes the step of adding ethyl alcohol to the saturated aqueous solution of sodium chloride prior to the step of adding the porous inorganic particles to the saturated aqueous solution.

15. The composition of claim 1, wherein the process further includes the step of heating the aqueous solution.

16. The composition of claim 2 wherein the ethyl alcohol has a percent purity of about 95% and is present in a quantity of about 12.5 to 5% by weight of the solution.

17. The composition of claim 3 wherein the ethyl alcohol is present in a quantity of 5% by weight of the solution.

18. The composiion of claim 1 wherein the porous inorganic particles comprise attapulgate clay.

19. The composition of claim 1 wherein the dimensions of the pores of the porous inorganic particles are within a range of 1525 Å.

20. The composition of claim 1 wherein the porous inorganic particles are characterized by a flat shape.

21. The composition of claim 1 wherein the porous inorganic particles are characterized by a spherical shape.

22. The composition of claim 1 wherein the sodium chloride is sea salt.
